(19) United States
(12) Patent Application Publication
(10) Pub. No.: US 2024/0258648 A1
(43) Pub. Date: Aug. 1, 2024

(54) SECONDARY BATTERY AND SECONDARY BATTERY MODULE

(71) Applicant: HONDA MOTOR CO., LTD., Tokyo (JP)

(72) Inventor: Takeshi FUJINO, Saitama (JP)

(21) Appl. No.: 18/422,000

(22) Filed: Jan. 25, 2024

(30) Foreign Application Priority Data
Jan. 31, 2023 (JP) 2023-012856

(51) Int. Cl. H01M 50/46; H01M 4/02; H01M 10/0569; H01M 50/136; H01M 50/491

(52) U.S. Cl. CPC H01M 50/46; H01M 10/0569; H01M 50/136; H01M 50/491; H01M 2004/021

(57) ABSTRACT

A secondary battery according to the present invention is a secondary battery including: an electrode laminated body comprising a positive electrode and a negative electrode laminated with each other via a separator; an electrolytic solution; and an exterior body accommodating the electrode laminated body and the electrolytic solution, in which a thickness of the negative electrode changes due to charging and discharging of electricity, the exterior body is able to expand and contract or deform in lamination directions of the electrode laminated body, and a space forming member forming an electrolytic solution temporary storing space that is able to absorb and discharge the electrolytic solution is disposed between at least one side surface, extending in the lamination directions, of the electrode laminated body and an inner surface of the exterior body.

This application is based on and claims the benefit of priority from Japanese Patent Application No. 2023-012856, filed on 31 Jan. 2023, the content of which is incorporated herein by reference.

### BACKGROUND OF THE INVENTION

### Field of the Invention

The present invention relates to a secondary battery and a secondary battery module.

### Related Art

In recent years, research and development regarding secondary batteries that contribute to energy efficiency has been undertaken to allow more people to secure accesses to convenient, reliable, sustainable, and advanced energy.

For example, to solve the problem of insufficiency of an electrolytic solution caused by the consumption of the electrolytic solution during charging and discharging, a secondary battery that accommodates an excess amount of the electrolytic solution in a battery case (an exterior body) in a state where the battery case is at rest to prevent the electrolytic solution from coming into contact with electrodes has been considered (Patent Document 1). It has been considered that the problem of insufficiency of the electrolytic solution can be solved because an excess amount of the electrolytic solution is impregnated into the electrodes when the secondary battery is shaken.
Patent Document 1: Japanese Unexamined Patent Application, Publication No. 2010-198953

### SUMMARY OF THE INVENTION

Incidentally, one issue in such a technique regarding a secondary battery and a secondary battery module is improvement in charge capacity. To improve the charge capacity of the secondary battery, using lithium metal or silicon particles as a negative electrode active material has been studied. In a lithium secondary battery using lithium metal or silicon particles, however, a thickness of a negative electrode greatly increases when electricity is charged, and the thickness of the negative electrode greatly decreases when electricity is discharged, leading to a case where electricity charging and discharging characteristics may lower. For example, in a lithium secondary battery using lithium metal as a negative electrode active material, separated lithium gradually changes from a particle state to a moss-like state when electricity is charged to form a negative electrode active material layer, increasing a thickness of a negative electrode, and the negative electrode active material layer (lithium metal) dissolves when electricity is discharged, decreasing the thickness of the negative electrode. In the negative electrode active material layer formed as the separated lithium gradually changes from the particle state to the moss-like state, voids tends to easily occur. As many voids are produced in the negative electrode active material layer, portions that are in contact with the many voids do not come into contact with an electrolytic solution, and are not able to contribute to charging and discharging of electricity. As a result, the charge capacity of the lithium secondary battery lowers. By supplying the electrolytic solution to the voids in the negative electrode active material layer, it is possible to improve the charge capacity. Since, in the secondary battery described in Patent Document 1, however, an excess amount of the electrolytic solution is accommodated and is prevented from coming into contact with the electrodes in a state where the battery case is at rest, it is difficult to supply the electrolytic solution to the voids in the negative electrode active material layer. Furthermore, when the electrolytic solution is supplied to the voids in the negative electrode active material, if there is no moving location for the electrolytic solution to promptly move when the negative electrode active material layer dissolves and the voids disappear while discharging, the electrolytic solution may become uneven between a positive electrode and the negative electrode leading to a case where in-plane resistance may become uneven, and resistance between the positive electrode and the negative electrode may increase. In particular, as the areas of the electrodes increase, uneven deposition of lithium metal may occur, along with negative effects of variations in holding pressure between the electrodes, leading to a case where durability of the lithium metal secondary battery may lower.

In view of solving the issues described above, an object of the present application is to provide a secondary battery and a secondary battery module that have high durability even though a negative electrode that increases in thickness when electricity is charged and decreases in thickness when electricity is discharged is used. Then, the present application is one that contributes to energy efficiency.

The inventors have found that, by disposing a space forming member forming an electrolytic solution temporary storing space that is able to absorb and discharge an electrolytic solution between at least one side surface, extending in lamination directions, of an electrode laminated body in which a positive electrode and a negative electrode are laminated with each other via a separator and an inner surface of an exterior body, and by using, as the exterior body of the secondary battery, one that is able to expand and contract or deform in the lamination directions of the electrode laminated body, it is possible to solve the issues described above, and have completed the present invention. Therefore, the present invention provides a secondary battery and a secondary battery module having configurations described below.
(1) A secondary battery includes:
   an electrode laminated body in which a positive electrode and a negative electrode are laminated with each other via a separator; an electrolytic solution; and an exterior body accommodating the electrode laminated body and the electrolytic solution, in which a thickness of the negative electrode changes due to charging and discharging of electricity, the exterior body is able to expand and contract or deform in lamination directions of the electrode laminated body, and a space forming member forming an electrolytic solution temporary storing space that is able to absorb and discharge the electrolytic solution is disposed between at least one side surface, extending in the lamination directions, of the electrode laminated body and an inner surface of the exterior body.

With the secondary battery described in (1), as the thickness of the negative electrode changes due to charging and discharging of electricity, and there is an excess amount of the electrolytic solution in the electrode laminated body, the excess amount of the electrolytic solution is discharged from the electrode laminated body, and is temporarily absorbed in the electrolytic solution temporary storing space. Furthermore, as there is insufficiency of the electrolytic solution in the electrode laminated body, the electrolytic solution is discharged from the electrolytic solution temporary storing space to the electrode laminated body. Therefore, durability of the secondary battery described in (1) improves for a long period of time. Furthermore, when a laminate film is used as an exterior body, it is possible, in a thermal fusion step of sealing the laminate film, to dispose a space forming member to define a position of a space between an electrolytic solution arrangement and a seal portion, preventing the electrolytic solution from coming into contact with the seal portion of the laminate film. Thereby, when the laminate film is heated for fusing, movement of heat to the electrolytic solution is limited, and a resin temperature at a fusing portion is stabilized, making it possible to securely perform fusing, and to prevent a liquid leak from occurring in cells.
(2) The secondary battery described in (1), in which, when the thickness of the negative electrode decreases, the electrolytic solution discharged from the electrode laminated body is absorbed in the electrolytic solution temporary storing space, and, when the thickness of the negative electrode increases, the electrolytic solution is discharged from the electrolytic solution temporary storing space to the electrode laminated body.

With the secondary battery described in (2), as the thickness of the negative electrode decreases due to discharging of electricity, and there is an excess amount of the electrolytic solution in the negative electrode, the excess amount of the electrolytic solution is discharged from the electrode laminated body, and the discharged electrolytic solution is absorbed in the electrolytic solution temporary storing space. Furthermore, as the thickness of the negative electrode increases due to charging of electricity, and there is insufficiency of the electrolytic solution in the electrode laminated body, the electrolytic solution is discharged from the electrolytic solution temporary storing space to the electrode laminated body. Therefore, even when charging and discharging of electricity are repeated, the durability improves.
(3) The secondary battery described in (1) or (2), in which the space forming member is a porous body.

With the secondary battery described in (3), since the space forming member is a porous body, it is possible to allow the electrolytic solution to be absorbed and discharged via hole portions. Thereby, unevenness in retaining amount and distribution of the electrolytic solution on surfaces of the electrodes in the electrode laminated body and the separator is further suppressed, further improving the durability.
(4) The secondary battery described in any one of (1) to (3), in which the exterior body has a sealer at a position separated away from the electrode laminated body, and the space forming member is disposed between the side surface, extending in the lamination directions, of the electrode laminated body and the sealer.

With the secondary battery described in (4), since the sealer of the exterior body is set at a position separated away from the side surface of the electrode laminated body, and the space forming member is disposed at a separated position, there is no waste in space efficiency in the secondary battery, improving energy density of the secondary battery. Furthermore, although, when the exterior body is to be sealed, the exterior body is pinched, with a conventional method, internally disposing the space forming member makes it possible to perform positioning of a pinching location.
(5) The secondary battery described in any one of (1) to (4), in which the electrode laminated body has a rectangular shape when seen in a plan view, and the space forming member is disposed along a long side of the electrode laminated body.

With the secondary battery described in (5), since the space forming member is disposed along the long side of the electrode laminated body, it is possible to shorten a moving distance for the electrolytic solution, compared with a case where the space forming member is disposed along a short side. Therefore, even when the thickness of the negative electrode increases due to charging of electricity, it is possible to easily and evenly supply the electrolytic solution to the negative electrode as a whole.
(6) The secondary battery described in any one of (1) to (5), in which the space forming member is an elastic member.

With the secondary battery described in (6), since the elastic member provides cushioning characteristics to the space forming member, disposing the space forming member contributes to protection of the electrode laminated body.
(7) The secondary battery described in any one of (1) to (6), in which the positive electrode includes a positive electrode current collector, and the negative electrode includes a negative electrode current collector, a positive electrode tab coupled to one side of the positive electrode current collector and a negative electrode tab coupled to one side of the negative electrode current collector are included, and the space forming member is disposed on a side to which the positive electrode tab and the negative electrode tab are not coupled.

With the secondary battery described in (7), since no tab is coupled to the side of the electrode laminated body, on which side the space forming member is disposed, it is possible to continuously dispose the space forming member.
(8) The secondary battery described in any one of (1) to (7), in which the electrolytic solution contains an organic solvent and an electrolyte, and a concentration of the electrolyte ranges from 0.5 mol/L to 4.0 mol/L inclusive.

With the secondary battery described in (8), since the electrolytic solution easily moves in the secondary battery, movement of the electrolytic solution is stabilized in the secondary battery, even when the concentration of the electrolyte falls within the range described above, suppressing such a case where electric characteristics lower due to uneven distribution of the electrolytic solution in the secondary battery. Therefore, cycle characteristics of the secondary battery improve.
(9) A secondary battery module includes: a battery laminated body comprising a plurality of secondary batteries laminated with each other; and a pair of end plates positioned at both ends, lying in lamination directions, of the battery laminated body, respectively, each of the secondary batteries being the secondary battery described in any one of (1) to (8) described above, the secondary batteries being laminated in the lamination directions of the electrode laminated body, the secondary battery module including elastic bodies each disposed between two adjacent ones of the secondary batteries in the battery laminated body and/or between one of the secondary batteries and one of the end plates, the elastic bodies each lying at a position overlapping with the electrode laminated body in each of the secondary batteries.

With the secondary battery module described in (9), as the thickness of the negative electrode in the secondary battery increases due to charging of electricity, the elastic body contracts in accordance with an amount of the increase of the thickness of the negative electrode, achieving an even load applied to the electrode laminated body. Therefore, charge capacity of the secondary battery improves. Furthermore, as the thickness of the negative electrode in the secondary battery decreases due to discharging of electricity, it is possible to allow the exterior body of the secondary battery to be evenly applied with pressure via the end plates in the lamination directions of the electrode laminated body, decreasing a remaining amount of the electrolytic solution supplied to the voids in the negative electrode active material layer. Therefore, durability of the secondary battery improves.
(10) The secondary battery module described in (9), in which the elastic bodies are each disposed at a position not overlapping with the space forming member in each of the secondary batteries.

With the secondary battery module described in (10), since no load is applied to the space forming member via the end plates, discharging of the electrolytic solution and degradation of the space forming member due to deformation of the space forming member, which is induced by an external force, are suppressed.
(11) The secondary battery module described in (9) or (10), in which, at an end, on a side adjacent to the space forming member in each of the secondary batteries, of each of the elastic bodies, an inclined portion having a downward inclination inclining toward each of the secondary batteries, is disposed.

With the secondary battery module described in (11), as the thickness of the negative electrode increases when electricity is charged, and the exterior body that is in contact with the electrode laminated body in the secondary battery expands or deforms, the space forming member is suppressed from coming into contact with a corner of the elastic body, between each two of the secondary batteries, and becoming damaged. Therefore, discharging of the electrolytic solution and degradation of the space forming member due to deformation of the space forming member, which is induced as the exterior body expands, are suppressed.
(12) The secondary battery module described in any one of (9) to (11), in which the plurality of secondary batteries are each disposed such that a side surface on a side adjacent to the space forming member is positioned on an upper side in a gravity direction than a side surface on a side opposite to the side adjacent to the space forming member in each of the secondary batteries.

With the secondary battery module described in (12), as the thickness of the negative electrode increases due to charging of electricity, the electrolytic solution absorbed in the space forming member can be supplied under its own weight to the electrode laminated body, so that the electrolytic solution can be supplied evenly to the voids in the negative electrode active material layer.

According to the present invention, in which even though the negative electrode that increases in thickness when electricity is charged and decreases in thickness when electricity is discharged is used, it is possible to provide a secondary battery and a secondary battery module that have high durability.

### BRIEF DESCRIPTION OF THE DRAWINGS

FIG. 1 is a side view illustrating an example of a secondary battery module according to an embodiment of the present invention;

FIG. 2 is a cross sectional view when seen in a plan view, illustrating an example of a secondary battery according to the embodiment of the present invention;

FIG. 3 is a cross sectional view of the secondary battery taken along line in FIG. 2;

FIG. 4 is a cross sectional view of the secondary battery taken along line IV-IV in FIG. 2;

FIG. 5 is an enlarged cross sectional view of a main part of the secondary battery illustrated in FIG. 3;

FIG. 6 is an enlarged cross sectional view of the main part of the secondary battery according to the embodiment of the present invention, illustrating a state after charging with electricity;

FIG. 7 is a view explaining voids in a porous film forming a space forming member of the secondary battery according to the embodiment of the present invention, where (a) is a cross sectional view, and (b) is a plan view illustrating a surface;

FIG. 8 is an enlarged cross sectional view of a main part illustrating another example of the secondary battery according to the embodiment of the present invention;

FIG. 9 is an enlarged cross sectional view of a main part illustrating still another example of the secondary battery module according to the embodiment of the present invention;

FIG. 10A is an enlarged cross sectional view of a main part illustrating still another example of the secondary battery module according to the embodiment of the present invention; and

FIG. 10B is an enlarged cross sectional view of the main part of the secondary battery module illustrated in FIG. 10A, illustrating a state after charging with electricity.

### DETAILED DESCRIPTION OF THE INVENTION

An embodiment of the present invention will now be described herein with reference to the accompanying drawings. However, the embodiment described below merely exemplifies the present invention. The present invention is not limited to the below description.

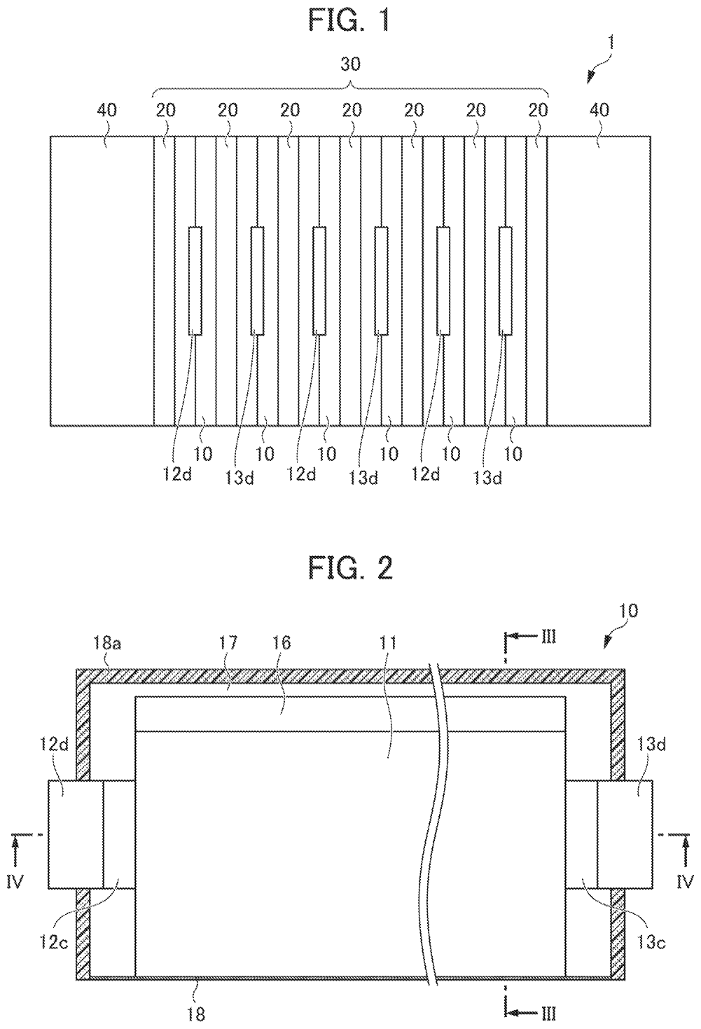

A secondary battery module 1 according to the embodiment of the present invention includes, as illustrated in FIG. 1, a battery laminated body 30 in which a plurality of secondary batteries 10 are laminated with each other, and a pair of end plates 40 positioned at both ends, lying in lamination directions, of the battery laminated body 30, respectively. Elastic bodies 20 are each disposed between two adjacent ones of the secondary batteries 10 in the battery laminated body 30 and between one of the secondary batteries 10 and one of the end plates 40.

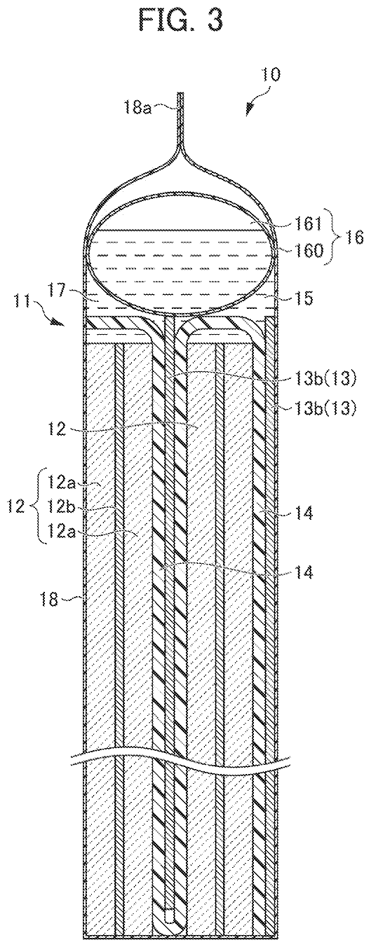

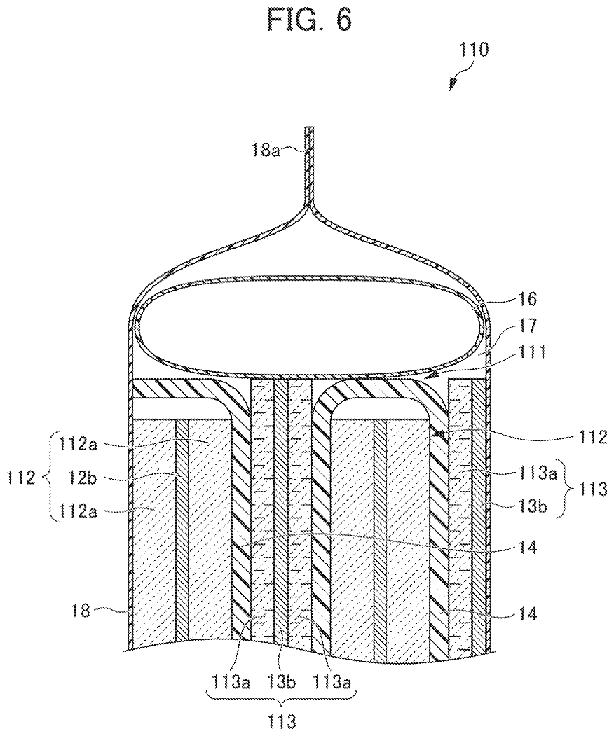

The secondary battery 10 in an electricity discharged state includes, as illustrated in FIGS. 2 to 5, an electrode laminated body 11, an electrolytic solution 15, and an exterior body 18 accommodating the electrode laminated body 11 and the electrolytic solution 15. A space forming member 16 is disposed between the electrode laminated body 11 and an inner surface of the exterior body 18. The space forming member 16 forms an electrolytic solution temporary storing space 17 that is able to absorb and discharge (i.e., receive and release) the electrolytic solution. The electrode laminated body 11 is a laminated body in which a positive electrode 12 and a negative electrode 13 are laminated with each other via a separator 14, and has a rectangular shape when seen in a plan view. The electrode laminated body 11 is impregnated with the electrolytic solution (not illustrated). The space forming member 16 is disposed between a side surface, extending in the lamination directions, of the electrode laminated body 11 and the inner surface of the exterior body 18. In the secondary battery module 1, the plurality of secondary batteries 10 are each disposed in such a manner that a side surface on which side the space forming member 16 is disposed serves as an upper side, and a side surface opposite to the side surface on which side the space forming member 16 is disposed serves as a lower side.

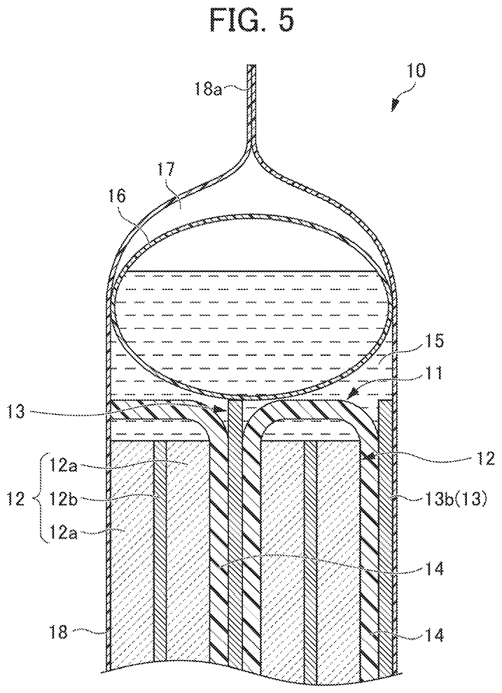

The positive electrode 12 includes positive electrode active material layers 12a and a positive electrode current collector 12b. The positive electrode current collector 12b is coupled, as illustrated in FIG. 4, to a positive electrode lead terminal 12d via a positive electrode tab 12c. The negative electrode 13 includes a negative electrode current collector 13b. The negative electrode current collector 13b is coupled, as illustrated in FIG. 4, to a negative electrode lead terminal 13d via a negative electrode tab 13c. The positive electrode lead terminal 12d and the negative electrode lead terminal 13d are disposed, respectively, at positions facing each other. Note that the electricity discharged state of the secondary battery 10 includes a state immediately after manufacture.

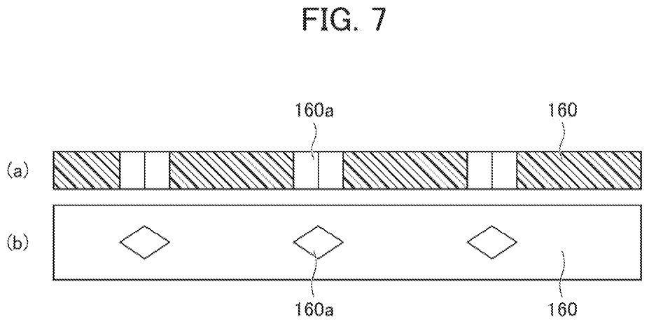

In a secondary battery 110 in an electricity charged state, as illustrated in FIG. 6, metal lithium is separated on a surface of the negative electrode current collector 13b to form a negative electrode active material layer 113a. The negative electrode active material layer 113a that has separated due to charging of electricity dissolves due to discharging of electricity. In this manner, a thickness of the negative electrode 13 in the electricity discharged state increases due to charging of electricity, and a thickness of a negative electrode 113 in the electricity charged state decreases due to discharging of electricity. A change in thickness between the positive electrode active material layers 12a in the positive electrode 12 in the electricity discharged state and positive electrode active material layers 112a in a positive electrode 112 in the electricity charged state is smaller than a change in thickness between the negative electrode 13 in the electricity discharged state and the negative electrode 113 in the electricity charged state. Therefore, a change in thickness between the electrode laminated body 11 in the electricity discharged state and an electrode laminated body 111 in the electricity charged state is normally substantially identical to a change in thickness between the negative electrode 13 in the electricity discharged state and the negative electrode 113 in the electricity charged state. A ratio in thickness of the electrode laminated body 11 in the electricity discharged state when a state of charge (SOC, or electricity charging rate) is 0% with respect to the electrode laminated body 111 in the electricity charged state when the SOC is 100% (Thickness of the electrode laminated body 111/Thickness of the electrode laminated body 11×100) may fall within a range equal to or higher than 110% and equal to or lower than 130%, for example.

The positive electrode active material layers 12a each contain a positive electrode active material. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1) , lithium manganese oxide (LiMn₂O₄), different kind element substituent Li—Mn spinels represented by Li₁₊ₓMn_{2-x-y}M_{y}O₄ (x+y=2, M=at least one type selected from a group consisting of Al, Mg, Co, Fe, Ni, and Zn), lithium titanate (oxides containing Li and Ti), and lithium metal phosphate (LiMPO₄, M=at least one type selected from a group consisting of Fe, Mn, Co, and Ni). The positive electrode active material layer may contain various types of additives used as materials for positive electrode active material layers, such as binders and conductive auxiliary agents.

As a material of the positive electrode current collector 12b, it is possible to use Al, for example. As a material of the positive electrode tab 12c and the positive electrode lead terminal 12d, it is possible to use a material that is identical to the material of the positive electrode current collector 12b.

As a material of the negative electrode current collector 13b, it is possible to use Cu, for example. As a material of a negative electrode tab 13c and the negative electrode lead terminal 13d, it is possible to use a material identical to the material of the negative electrode current collector 13b.

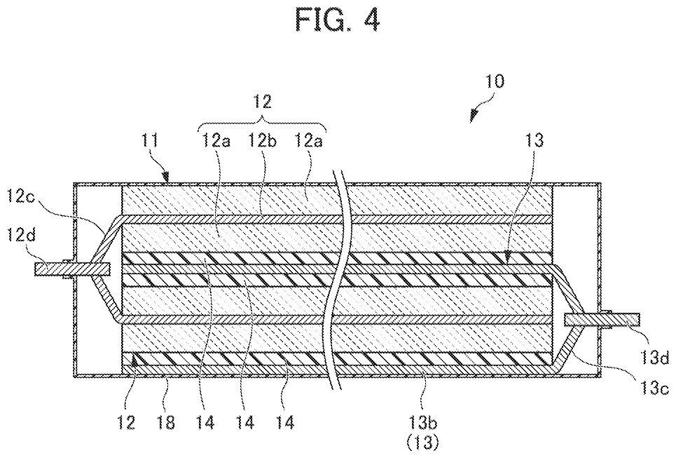

As the separator 14, it is possible to use, but not particularly limited to, a porous body sheet or a non-woven fabric sheet, for example. Example materials of the porous body sheet include polyolefin such as polyethylene and polypropylene, aramid, polyimide, and a fluororesin. Example materials of the non-woven fabric sheet include glass fiber and cellulose fiber. The separator 14 is folded in a zigzag manner, as illustrated in FIG. 3.

The electrolytic solution 15 is identical in composition to the electrolytic solution (not illustrated) impregnated into the electrode laminated body 11. The electrolytic solution 15 contains an organic solvent and an electrolyte. As the organic solvent, it is possible to use, for example, cyclic carbonate, chain carbonate, cyclic ether, chain ether, hydro fluoro ether, aromatic ether, sulfone, cyclic ester, chain carboxylic acid ester, and nitrile. Examples of cyclic carbonate include ethylene carbonate, propylene carbonate, vinylene carbonate, and fluoro ethylene carbonate. Examples of chain carbonate include dimethyl carbonate, diethyl carbonate, and ethylmethyl carbonate. Examples of cyclic ether include tetrahydrofuran, 2-methyltetrahydrofuran, tetrahydropyran, 1,3-dioxolane, and 4-methyl 1,3-dioxolane. Examples of chain ether include 1,2-dimethoxyethane, 1,2-diethoxyethane, ethoxymethoxyethane, and diethylether. Examples of hydro fluoro ether include 1,1,2,2-tetrafluoroethyl-2,2,2-trifluoroethylether, 1,1,2,2-tetrafluoroethyl-2,2,3,3-tetrafluoropropylether, bis(2,2,2-trifluoroethyl)ether, and 1,2-bis(1,1,2,2-tetrafluoroethoxy)ethane. An example of aromatic ether is anisole. Examples of sulfone include sulfolane and metylsulfolane. An example of cyclic ester is γ-butyrolactone. Examples of chain carboxylic acid ester include acetic ester, butyric acid ester, and propionic acid ester. Examples of nitrile include acetonitrile and propionitrile. For the organic solvent, one type may be solely used, or two or more types may be used in a combined manner.

The electrolyte is a supply source of lithium ions serving as an electrical charge moving medium, and contains lithium salt. Examples of lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. For the lithium salt, one type may be solely used, or two or more types may be used in a combined manner. A concentration of the electrolyte may range from 0.5 mol/L to 4.0 mol/L inclusive, may range from 1.0 mol/L to 4.0 mol/L inclusive, and may range from 2.0 mol/L to 4.0 mol/L inclusive, for example. The electrolytic solution 15 generally tends to increase in viscosity, and its movement tends to be less likely to occur in the secondary battery 10, as the concentration of the electrolyte increases. Since the secondary battery 10 according to the present embodiment has the electrolytic solution temporary storing space 17, the electrolytic solution 15 easily moves in the secondary battery 10, even when the concentration of the electrolyte is high.

Although a content of the electrolytic solution 15 in the secondary battery 10 is not particularly limited, it is desirable that the content range from 1.0 mL/Ah to 1.8 mL/Ah inclusive, based on, as a reference, charge capacity (unit: Ah) of the secondary battery 10, that is, the negative electrode active material layer 113a generated in the electricity charged state, for example. Furthermore, it is desirable that an amount of the electrolytic solution 15 stored in the electrolytic solution temporary storing space 17 immediately after the secondary battery 10 is manufactured ranges from 0.2 mL/Ah to 0.6 mL/Ah inclusive.

The space forming member 16 may be an elastic member. When the space forming member is an elastic member having cushioning characteristics, it is possible to protect the electrode laminated body 11 from an external force. Furthermore, it is desirable that the space forming member 16 has strength to an extent that allows buckling when the exterior body 18 is sealed, and the electrolytic solution 15 be able to easily penetrate.

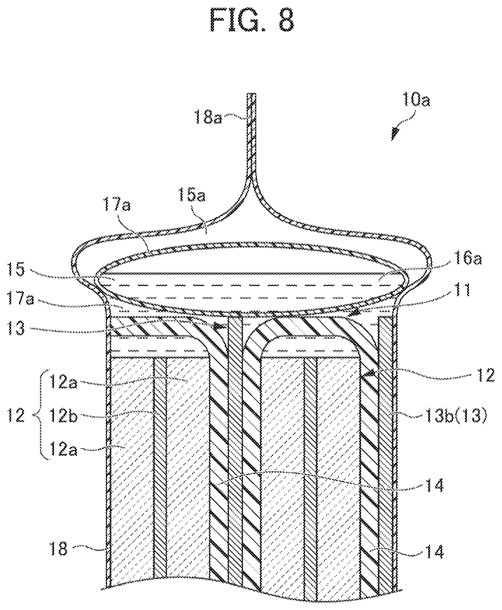

In the present embodiment, the space forming member 16 is a hollow body having a cylindrical shape. The space forming member 16 is, as illustrated in FIG. 3, a hollow porous body having a porous film 160 and a space 161 formed inside the porous film 160. The porous film 160 has holes 160a through which the electrolytic solution 15 is able to pass, as illustrated in FIG. 7. Example materials of the porous film 160 include resins such as polyethylene and polypropylene. The space 161 inside the space forming member 16 and a space between the space forming member 16 and the electrode laminated body 11 form the electrolytic solution temporary storing space 17. Note that, although, as illustrated in FIG. 3, the space 161 in the space forming member 16 is not filled with the electrolytic solution 15, but another space is remaining, the space 161 may be fully filled with the electrolytic solution 15. Furthermore, a foam body having through holes may be used as the space forming member 16, instead of the hollow porous body.

The electrolytic solution temporary storing space 17 is made to be able to absorb and discharge the electrolytic solution 15. To achieve effective charging and discharging of electricity in the secondary battery 10, it is necessary to allow the electrolytic solution 15 to be evenly present on a surface of the negative electrode active material layer 113a. In the negative electrode active material layer 113a that has separated due to charging of electricity, generally, voids tend to be formed. Therefore, the secondary battery 110 in the electricity charged state tends to become a state where the electrolytic solution 15 is insufficient in the electrode laminated body 111. In the present embodiment, allowing, even when the electrolytic solution 15 becomes insufficient in the electrode laminated body 111, the electrolytic solution 15 to be discharged from the electrolytic solution temporary storing space 17 to the electrode laminated body 111 to supply the electrolytic solution 15 to the voids in the negative electrode active material layer 113a makes it possible to allow the electrolytic solution to be evenly present on the surface of the negative electrode active material layer 113a. When the negative electrode active material layer 113a has dissolved due to discharging of electricity in the secondary battery 110 in the electricity charged state, on the other hand, there is an excess amount of the electrolytic solution 15 in the electrode laminated body 111 due to the supplied electrolytic solution. In the present embodiment, allowing, even when there is an excess amount of the electrolytic solution 15 in the electrode laminated body 111, the excess amount of the electrolytic solution 15 to be discharged from the electrode laminated body 111 and to be absorbed by the electrolytic solution temporary storing space 17 makes it possible to allow the electrolytic solution to be evenly present on the surface of the negative electrode active material layer 113a.

The electrolytic solution temporary storing space 17 is formed between the side surface, extending in the lamination directions, of the electrode laminated body 11 and a sealer 18a on the exterior body 18. Forming the electrolytic solution temporary storing space 17 between the side surface of the electrode laminated body 11 and the sealer 18a makes it possible to effectively utilize a space in the secondary battery 10, improving energy density of the secondary battery 10. Furthermore, the electrolytic solution temporary storing space 17 is disposed along a long side of the electrode laminated body 11. Therefore, it is possible to reduce an amount of movement of the electrolytic solution 15, compared with a case where the electrolytic solution temporary storing space 17 is disposed along a short side of the electrode laminated body 11. Thereby, it is possible to evenly supply the electrolytic solution 15 onto the surface of the negative electrode active material layer 113a wholly in the negative electrode 113 in the electricity charged state.

The exterior body 18 is made to be able to expand and contract or deform in the lamination directions of the electrode laminated body 11. When the thickness of the negative electrode 13 increases due to charging of electricity, the exterior body 18 expands in accordance with the increase of the thickness. Furthermore, when the thickness of the negative electrode 13 decreases due to discharging of electricity, the exterior body 18 contracts in accordance with the decrease of the thickness. The exterior body 18 has the sealer 18a at a position separated away from the electrode laminated body 11. As a material of the exterior body 18, it is possible to use a laminate film. As the laminate film, it is possible to use a laminated film having a three-layer structure in which an inner resin layer, a metal layer, and an outer resin layer are laminated with each other from its inside in this order. The inner resin layer may be, for example, a polyamide (nylon) layer or a polyethylene terephthalate (PET) layer. The metal layer may be, for example, an aluminum layer. The inner resin layer may be, for example, a polyethylene layer or a polypropylene layer.

It is possible to manufacture the secondary battery 10 as described below, for example. The electrode laminated body 11 and the space forming member 16 are first prepared. It is possible to acquire the electrode laminated body 11 by, for example, producing a laminated body in which the positive electrode 12 and the negative electrode 13 are laminated with each other via the separator 14, and then coupling the positive electrode tab 12c to the positive electrode 12, and coupling the negative electrode tab 13c to the negative electrode 13, respectively. Then, the electrode laminated body 11 and the space forming member 16 are placed in the exterior body 18 to couple the positive electrode lead terminal 12d to the positive electrode tab 12c, and couple the negative electrode lead terminal 13d to the negative electrode tab 13c, respectively. After the electrolytic solution 15 is poured in the exterior body 18, and the space forming member 16 is allowed to store some of the electrolytic solution 15, the exterior body 18 is then sealed. When the exterior body 18 is to be sealed, it is possible to use a method of pinching the exterior body 18 with jigs. In the present embodiment, disposing the space forming member 16 makes it possible to easily perform positioning of a location of pinching the exterior body 18.

In the battery laminated body 30 in the secondary battery module 1, the plurality of secondary batteries 10 are laminated with each other in the lamination directions of the electrode laminated body 11. In the present embodiment, the plurality of secondary batteries 10 are laminated with each other in such a manner that the positive electrode lead terminals 12d and the negative electrode lead terminals 12d are alternately arranged to make serial coupling easier. Note that the plurality of secondary batteries 10 may be laminated with each other in such a manner that the positive electrode lead terminals 12d are disposed on one side, and the negative electrode lead terminals 12d are disposed on another side to make parallel coupling easier.

The elastic body 20 is one that is able to be compressed when an expansion force is received from the secondary battery 10 as the thickness of the negative electrode 13 increases due to charging of electricity to absorb the expansion force. As the elastic body 20, it is possible to use one of a metal spring, a porous resin foam body, and rubber such as natural rubber, diene based rubber, or non-diene based rubber. For those elastic bodies, one type may be solely used, or two or more types may be used in a combined manner.

The pair of end plates 40 are restrained by a fastening member (not illustrated). The pair of end plates 40 transmit a restraining force applied by the fastening member to the battery laminated body 30 to apply pressure to the battery laminated body 30 in the lamination directions. Since the secondary battery 110 in the electricity charged state is applied with pressure in the lamination directions of the electrode laminated body 111, it is thereby possible to easily allow, when the thickness of the negative electrode 113 decreases due to discharging of electricity in the secondary battery 110, an excess amount of the electrolytic solution 15 in the negative electrode 113 to be pushed out of the electrode laminated body 111. A material of the end plates 40 is not particularly limited, but it is possible to use various types of materials utilized for end plates for battery modules.

With the secondary battery 10 according to the present embodiment having such a configuration as described above, it is possible to allow, when the thickness of the negative electrode 13 increases due to charging of electricity in the secondary battery 10 in the electricity discharged state, the electrolytic solution 15 absorbed in the space forming member 16 to be discharged to the electrode laminated body 111 in the electricity charged state to supply the electrolytic solution 15 to the voids in the negative electrode active material layer 113a. Therefore, the charge capacity improves. Furthermore, it is possible to allow, when the thickness of the negative electrode 113 decreases due to discharging of electricity in the secondary battery 110 in the electricity charged state, the exterior body 18 to receive pressure in the lamination directions of the electrode laminated body 11, to push out the electrolytic solution 15 supplied to the voids in the negative electrode active material layer 113a from the electrode laminated body 111 to allow the space forming member 16 to absorb and collect the electrolytic solution. Therefore, durability of the secondary battery 10 improves.

With the secondary battery module 1 according to the present embodiment having such a configuration as described above, it is possible to allow, when the thickness of the negative electrode 13 increases due to charging of electricity in the secondary battery 10 in the electricity discharged state, the electrolytic solution 15 absorbed in the space forming member 16 to be discharged to the electrode laminated body 111 in the electricity charged state to supply the electrolytic solution 15 to the voids in the negative electrode active material layer 113a. Since it is possible to allow the electrolytic solution 15 to be evenly present on the surface of the negative electrode active material layer 113a during charging of electricity, the charge capacity thereby improves. Furthermore, it is possible to allow, when the thickness of the negative electrode 113 decreases due to discharging of electricity in the secondary battery 110 in the electricity charged state, an excess amount of the electrolytic solution 15 to be discharged from the electrode laminated body 111 and to be absorbed in the electrolytic solution temporary storing space 17. Therefore, discharge capacity improves. Since it is possible to allow the electrolytic solution 15 to be evenly present on the surface of the negative electrode active material layer 113a during discharging of electricity, the discharge capacity thereby improves. With the secondary battery module 1 according to the present embodiment, the durability of the secondary battery 10 therefore improves, even though such a negative electrode that increases in thickness when electricity is charged and decreases in thickness when electricity is discharged has been used.

Note that the present invention is not limited to the embodiment described above, but the embodiment described above may be modified appropriately within the scope of the present invention.

Although, in the secondary battery module 1 according to the embodiment described above, the space forming member 16 in each of the secondary batteries 10 has been disposed between the side surface of the electrode laminated body 11 and the sealer 18a, the position at which the space forming member 16 is disposed is not limited to this case. For example, the space forming member 16 may be disposed on an opposite side to the side on which the sealer 18a is disposed. However, it is desirable that the space forming member 16 be disposed on a side to which the positive electrode tab 12c and the negative electrode tab 13c of the electrode laminated body 11 are not coupled. Thereby, it is possible to continuously dispose the space forming member 16.

Although, in the secondary battery module 1 according to the embodiment described above, the negative electrode active material layer 113a in each of the secondary batteries 10 is made of metal lithium that separates due to charging of electricity and dissolves due to discharging of electricity, the material of the negative electrode active material layer 113a is not limited to this case. For example, such a substance may be used as the material of the negative electrode active material layer, that takes lithium when electricity is charged and discharges lithium when electricity is discharged. As such a substance as described above, it is possible to use one of or a composite material of silicon particles and silicon oxide particles.

Although, in the secondary battery module 1 according to the embodiment described above, the electrode laminated body 11 has a rectangular shape when seen in a plan view, the shape of the electrode laminated body 11 is not limited to this case. For example, the electrode laminated body 11 may have a square shape when seen in a plan view.

Although, in the secondary battery module 1 according to the embodiment described above, the elastic bodies 20 have been each disposed between two adjacent ones of the secondary batteries 10 in the battery laminated body 30 and between one of the secondary batteries 10 and one of the end plates 40, the positions at which the elastic bodies 20 are disposed are not limited to this case. As long as it is possible to apply a constant load to the electrode laminated bodies 11, the elastic bodies 20 may be each disposed only between two adjacent ones of the secondary batteries 10 or only between one of the secondary batteries 10 and one of the end plates 40, for example.

Although, in the secondary battery module 1 according to the embodiment described above, the plurality of secondary batteries 10 are each disposed in such a manner that the side surface on which side the space forming member 16 is disposed serves as the upper side, and the side surface opposite to the side surface on which side the space forming member 16 is disposed serves as the lower side, the disposition of the secondary batteries 10 is not limited to this case. However, it is desirable that the plurality of secondary batteries 10 be each disposed in such a manner that the side surface on which side the space forming member 16 is disposed at a higher position in the gravity direction than the side surface opposite to the side surface on which side the space forming member 16 in each of the secondary batteries 10 is disposed. Since it is possible to allow, by its weight, the electrolytic solution 15 in the electrolytic solution temporary storing space 17 to move to the electrode laminated body 111 in the secondary battery 110 in the electricity charged state, it is thereby possible to evenly supply the electrolytic solution 15 to the voids in the negative electrode active material layer 113a.

Although, in the secondary battery module 1 according to the embodiment described above, the space forming member 16 in each of the secondary batteries 10 has been a hollow body having a cylindrical shape, the shape of the space forming member 16 is not limited to this case.

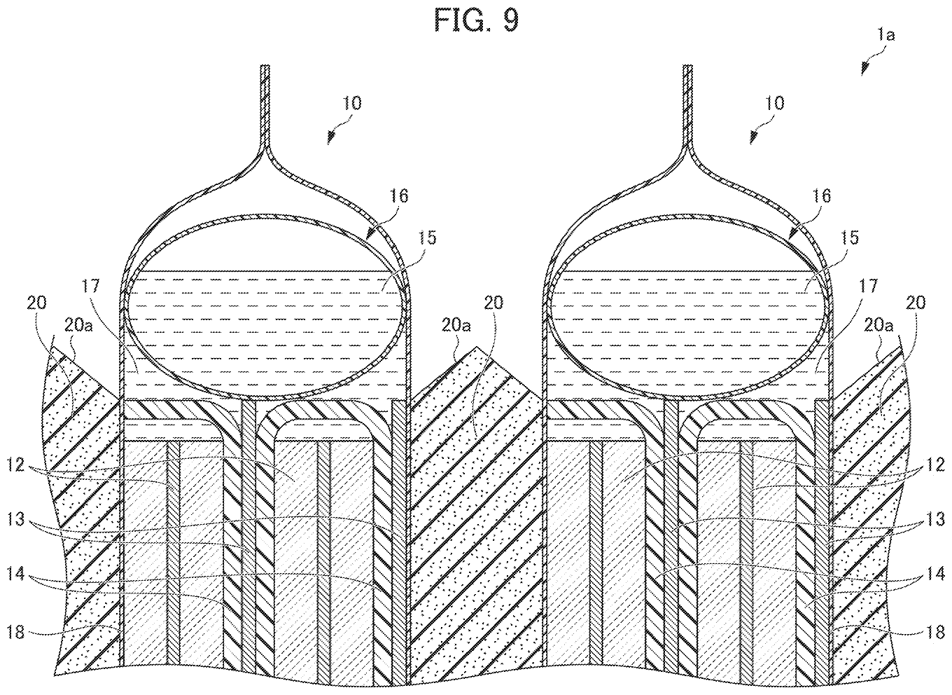

In a secondary battery 10a illustrated in FIG. 8, a cross section of a space forming member 16a has an elliptical shape that is pressed in directions vertical to the lamination directions of the electrode laminated body 11. Since the secondary battery 10a according to the present embodiment has a configuration identical to that of the secondary battery 10 described above, excluding the space forming member 16a, identical reference numerals are applied, and their detailed descriptions are omitted.

Since, with the secondary battery 10a illustrated in FIG. 8, the space forming member 16a is able to discharge and absorb the electrolytic solution 15, its durability improves, similar to the secondary battery 10. Furthermore, when the exterior body 18 is pinched and sealed with heat seal bars, application of a force to the electrode laminated body 11 via the space forming member 16a is suppressed.

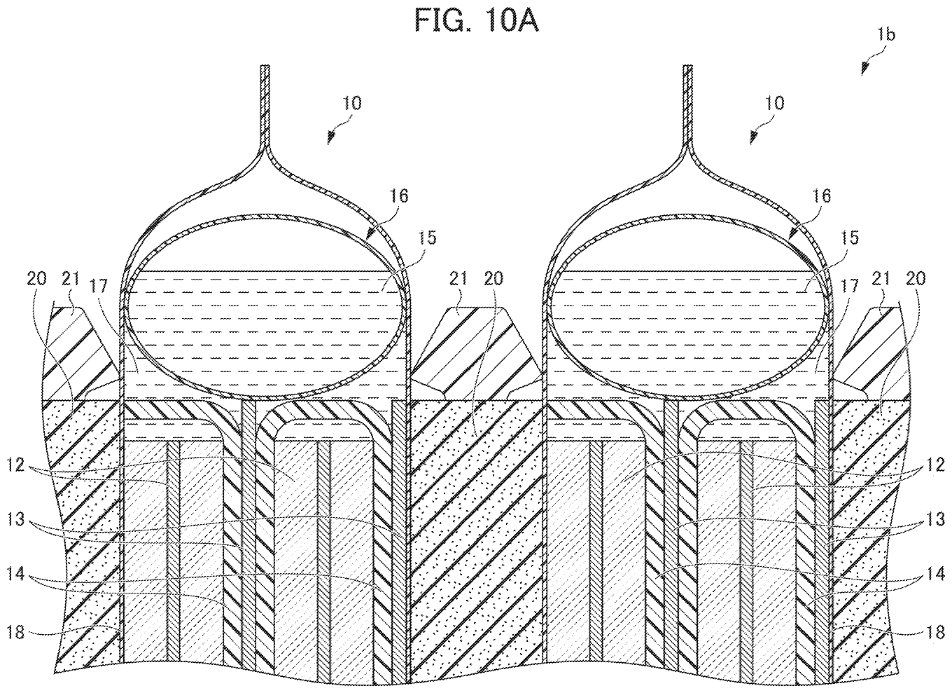

In a secondary battery module 1a illustrated in FIG. 9, an inclined portion 20a is formed at an end, on a side adjacent to the space forming member 16, of the elastic body 20. The inclined portion 20a has a downward inclination inclined toward the secondary battery 10. The elastic body 20 is in contact with the exterior body 18 at a position facing the electrode laminated body 11, and the inclined portion 20a lies at a position facing the space forming member 16. Since the secondary battery module 1a according to the present embodiment has a configuration identical to that of the secondary battery module 1 described above, excluding the elastic bodies 20, identical reference numerals are applied, and their detailed descriptions are omitted.

With the secondary battery module 1a illustrated in FIG. 9, its durability improves, similar to the secondary battery module 1 described above. Furthermore, since the elastic body 20 is, at the position facing the electrode laminated body 11, in contact with, but is, at a position facing the space forming member 16, not in contact with the exterior body 18, no load is applied to the space forming member 16 via the end plates 40. Therefore, discharging of the electrolytic solution and degradation of the space forming member due to deformation of the space forming member 16, which is induced by an external force, are suppressed. Furthermore, since the inclined portion 20a is formed at the end, on the side adjacent to the space forming members 16, of the elastic body 20, the space forming member 16 is prevented from coming into contact with a corner of the elastic body 20 and becoming damaged when the thickness of the negative electrode 13 increases during charging of electricity and the exterior body 18 that is in contact with the electrode laminated body 11 in the secondary battery 10 has expanded.

Furthermore, the space forming member 16 may have such a shape that, in the electricity charged state, an end on a side adjacent to the electrode laminated body 111 is longer in length than an end on an opposite side to the side adjacent to the electrode laminated body 111 in the lamination directions of the electrode laminated body 111. Since, in this case, an area of contact between the space forming member 16 and the electrode laminated body 111 increases, it is possible to promptly supply the electrolytic solution 15 to the negative electrode 113 in the electricity charged state.

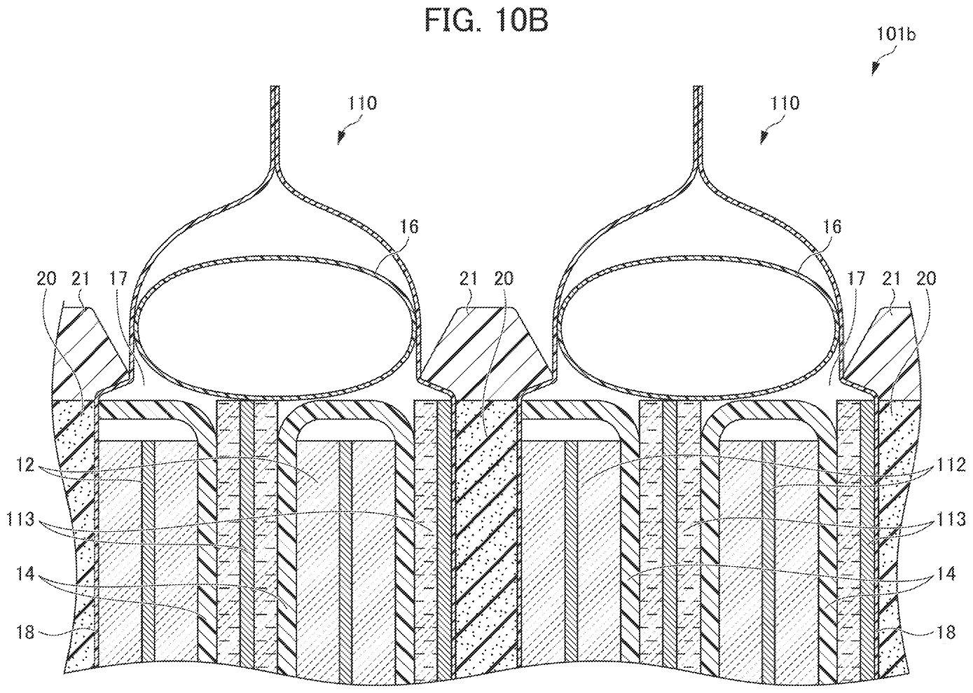

The secondary battery module 1a illustrated in FIG. 10A has a shape where each of the elastic bodies 20 is only disposed at a position not overlapping with the space forming member 16 in the secondary battery 10, that is, at a position overlapping with the electrode laminated body 11. Furthermore, an inclined member 21 having a downward inclination inclined toward the secondary battery 10 is disposed at an end, on a side adjacent to the space forming member 16 in the secondary battery 10, of the elastic body 20. As a material of the inclined member 21, it is possible to use a hard resin. Since the secondary battery module according to the present embodiment has a configuration identical to that of the secondary battery module 1 described above, excluding the elastic bodies 20 and the inclined members 21, identical reference numerals are applied, and their detailed descriptions are omitted.

With the secondary battery module 1b illustrated in FIG. 10A, its durability improves, similar to the secondary battery module 1 described above. Furthermore, since no load is applied to the space forming member 16 via the end plates 40, discharging of the electrolytic solution and degradation of the space forming member due to deformation of the space forming member 16, which is induced by an external force, are suppressed. Furthermore, when the thickness of the negative electrode 113 increases due to charging of electricity, and the exterior body 18 that is in contact with the electrode laminated body 11 in the secondary battery has expanded, similar to a secondary battery module 101b in a state after charging of electricity, as illustrated in FIG. 10B, the inclined member 21 suppresses expansion of the exterior body 18 at a position adjacent to the space forming member 16. Therefore, discharging of the electrolytic solution 15 and degradation of the space forming member due to deformation of the space forming member 16, which is induced as the exterior body 18 expands, are suppressed.

### EXPLANATION OF REFERENCE NUMERALS

1, 1a, 1b, 101b Module
10, 10a, 10b, 110 Secondary battery
11 Electrode laminated body
12, 112 Positive electrode
12a Positive electrode active material layer
12b Positive electrode current collector
12c Positive electrode tab
12d Positive electrode lead terminal
13, 113 Negative electrode
113a Negative electrode active material layer
13b Negative electrode current collector
13c Negative electrode tab
13d Lead terminal
14 Separator
15 Electrolytic solution
16, 16a Space forming member
160 Porous film
160a Hole
161 Space
17, 17a Electrolytic solution temporary storing space
18 Exterior body
18a Sealer
20 Elastic body
20a Inclined portion
21 Inclined member
30 Battery laminated body
40 End plate

What is claimed is:

1. A secondary battery comprising:
an electrode laminated body in which a positive electrode and a negative electrode are laminated with each other via a separator;
an electrolytic solution; and
an exterior body accommodating the electrode laminated body and the electrolytic solution,
wherein
a thickness of the negative electrode changes due to charging and discharging of electricity,
the exterior body is able to expand and contract or deform in lamination directions of the electrode laminated body, and
a space forming member forming an electrolytic solution temporary storing space that is able to absorb and discharge the electrolytic solution is disposed between at least one side surface, extending in the lamination directions, of the electrode laminated body and an inner surface of the exterior body.

2. The secondary battery according to claim 1, wherein, when the thickness of the negative electrode decreases, the electrolytic solution discharged from the electrode laminated body is absorbed in the electrolytic solution temporary storing space, and, when the thickness of the negative electrode increases, the electrolytic solution is discharged from the electrolytic solution temporary storing space to the electrode laminated body.

3. The secondary battery according to claim 1, wherein the space forming member is a porous body.

4. The secondary battery according to claim 1, wherein
the exterior body has a sealer at a position separated away from the electrode laminated body, and
the space forming member is disposed between the side surface, extending in the lamination directions, of the electrode laminated body and the sealer.

5. The secondary battery according to claim 1, wherein
the electrode laminated body has a rectangular shape when seen in a plan view, and
the space forming member is disposed along a long side of the electrode laminated body.

6. The secondary battery according to claim 1, wherein the space forming member is an elastic member.

7. The secondary battery according to claim 1, wherein
the positive electrode includes a positive electrode current collector, and the negative electrode includes a negative electrode current collector,
a positive electrode tab coupled to one side of the positive electrode current collector and a negative electrode tab coupled to one side of the negative electrode current collector are included, and
the space forming member is disposed on a side to which the positive electrode tab and the negative electrode tab are not coupled.

8. The secondary battery according to claim 1, wherein
the electrolytic solution contains an organic solvent and an electrolyte, and
a concentration of the electrolyte ranges from 0.5 mol/L to 4.0 mol/L inclusive.

9. A secondary battery module comprising:
a battery laminated body comprising a plurality of secondary batteries laminated with each other; and
a pair of end plates positioned at both ends, lying in lamination directions, of the battery laminated body, respectively,
each of the secondary batteries being the secondary battery according to claim 1,
the secondary batteries being laminated in the lamination directions of the electrode laminated body,
the secondary battery module including elastic bodies each disposed between two adjacent ones of the secondary batteries in the battery laminated body and/or between one of the secondary batteries and one of the end plates,
the elastic bodies each lying at a position overlapping with the electrode laminated body in each of the secondary batteries.

10. The secondary battery module according to claim 9, wherein the elastic bodies are each disposed at a position not overlapping with the space forming member in each of the secondary batteries.

11. The secondary battery module according to claim 9, wherein the elastic bodies each have, at an end on a side adjacent to the space forming member in each of the secondary batteries, an inclined portion having a downward inclination inclining toward each of the secondary batteries.

12. The secondary battery module according to claim 9, wherein the plurality of secondary batteries are each disposed such that a side surface on a side adjacent to the space forming member is positioned on an upper side in a gravity direction than a side surface on a side opposite to the side adjacent to the space forming member in each of the secondary batteries.
